(19) United States
(12) Patent Application Publication
(10) Pub. No.: US 2011/0047438 A1
(43) Pub. Date: Feb. 24, 2011

(54) COMPUTER AND DATA STORAGE METHOD

(75) Inventor: Song Lin, Shenzhen (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NETAC TECHNOLOGY CO., LTD., Shenzhen (CN)

(21) Appl. No.: 12/895,965

(22) Filed: Oct. 1, 2010

(30) Foreign Application Priority Data
Apr. 2, 2008 (CN) 200810087552.5
Apr. 2, 2009 (WO) CN2009/071144

(51) Int. Cl. G06F 11/08; G06F 13/28; G06F 12/02

(52) U.S. Cl. 714/758; 711/103; 710/308; 714/E11.03; 711/E12.008

(57) ABSTRACT

A computer and a method for accessing data in the computer are provided. The computer comprises a mainboard chipset, a conventional hard disk, a flash memory and a controller. The controller is connected with the flash memory and selectively stores data to the hard disk or the flash memory according to the command from the mainboard chipset. The mainboard chipset is the south bridge chipset. The controller comprises a data interface unit in communication with the south bridge chipset, a controlling unit configured to receive the command through the data interface unit, and a flash memory accessing unit connected with the flash memory. The controlling unit controls the flash memory accessing unit to exchange the data with the south bridge chipset through the data interface unit according to the received command.

### CROSS-REFERENCES TO RELATED APPLICATIONS

The present application is a continuation and claims benefit of International Application No. PCT/CN2009/071144, filed on Apr. 2, 2009, which claims benefit of Chinese Patent Application No. 200810087552.5, filed on Apr. 2, 2008, the contents of which are incorporated herein by reference in its entirety.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### TECHNICAL FIELD

The present application relates to the field of computers, and in particular to a computer and a method for storing data in the computer.

### BACKGROUND OF THE INVENTION

A conventional hard disk is generally used as a mass storage device in a computer to store mass data. Data stored in the hard disk is often called and processed by a random access memory such as RAM and DRAM. A sector inquiring speed for accessing a hard disk is much slower than that for accessing a Dynamic Random Access Memory (DRAM) of a processor, no matter it is a PATA hard disk or a SATA hard disk. Thus, speeds for booting the computer and processing data in the computer are limited.

Nowadays, the speed of data processing has been improved by Solid State Disk (SSD) technology which uses a flash memory instead of a mechanic hard disk as a storage device. However, its high cost and low capacity cannot satisfy users.

Therefore, a hard disk with a low cost, a high capacity and a fast processing speed is highly desired.

### BRIEF SUMMARY OF THE INVENTION

This application aims to provide a computer and a method for storing data in the computer, which at least promote the booting and processing speeds of a computer system as well as the accessing speed of a main storage device thereof.

According to an aspect of the application, a computer comprises a mainboard chipset; a conventional hard disk a flash memory; and a controller connected to the flash memory for selectively storing data to the hard disk or the flash memory according to a command received from the mainboard chipset.

Optionally, the mainboard chipset is a south bridge chipset.

The controller may comprises a data interface unit in communication with the south bridge chipset; a controlling unit receiving the command via the data interface unit; and a flash memory accessing unit connected to the flash memory, wherein the controlling unit controls the flash memory accessing unit to exchange data with the south bridge chipset via the data interface unit according to the command.

According to another aspect, provided is a method for accessing data in a computer, wherein the computer comprises a conventional hard disk and a flash memory. The method comprises: receiving a data writing command and data to be written; analyzing the received command to determine whether a size of the data is larger than an available storage space on the flash memory; and if the size of the data is larger than the available storage space on the flash memory, then writing the data in the conventional hard disk; otherwise, writing the data in the flash memory.

The method may further comprises determining whether the available storage space on the flash memory is larger than a preset threshold; and if the available storage space on the flash memory is smaller than the preset threshold, then transferring part of data on the flash memory to the conventional hard disk.

Alternatively, the method for accessing data in a computer according to the another aspect of the application may comprises: detecting whether an available storage space on the flash memory is larger than a preset threshold; if the available storage space is smaller than a preset threshold, then writing the data in the flash memory; otherwise, determining whether a size of the data is larger than the available storage space on the flash memory; if the size of the data is smaller than the available storage space on the flash memory, then writing the data in the flash memory; otherwise, writing the data in the conventional hard disk.

According to the above computer and methods, data may be selectively stored in a flash memory or a hard disk so that the data accessing speed in the computer, the booting and running speed of the operating system of the computer are improved.

### BRIEF DESCRIPTION OF THE DRAWINGS

FIG. 1 is a schematic block diagram of a computer according to a first embodiment of a first aspect of the present application;

FIG. 2 is a detailed schematic diagram of the flash memory accessing unit 204 in FIG. 1;

FIG. 3 is a schematic block diagram of a computer according to a second embodiment of the first aspect of the present application;

FIG. 4 is a schematic block diagram of a computer according to a third embodiment of the first aspect of the present application;

FIG. 5 is a flow diagram showing a computer accessing method according to a first embodiment of a second aspect of the present application;

FIG. 6 is a flow diagram showing a computer accessing method according to a second embodiment of the second aspect of the present application; and

FIG. 7 is a flow diagram showing a computer accessing method according to a third embodiment of the second aspect of the present application.

### DETAILED DESCRIPTION OF THE INVENTION

A computer according to this application comprises at least a mainboard chipset, a conventional hard disk, a flash memory and a controller, wherein the controller is connected to the flash memory and selectively stores data into the hard disk or the flash memory according to a command from the mainboard chipset. Hereinafter, taking a data writing operation as an example, embodiments according to the present application will be described with reference to the accompanying drawings.

### Embodiment 1

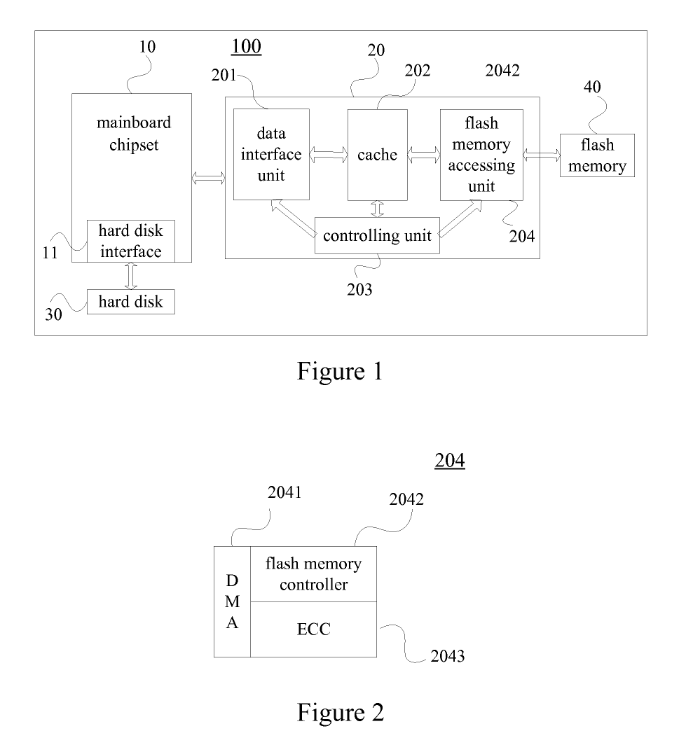

Referring to FIG. 1, a computer 100 according to a first embodiment of a first aspect of the present application comprises a CPU (not shown) and a mainboard chipset 10 in data communication with the CPU. The mainboard chipset 10 is a south bridge chipset, and is connected to a conventional hard disk 30 via a hard disk interface 11. The hard disk 30 may be a hard disk such as a PATA hard disk or a SATA hard disk.

The computer 100 further comprises a controller 20 in communication with the mainboard chipset 10. As shown in FIG. 1, the controller 20 may comprise a data interface unit 201, a cache unit 202, a controlling unit 203 and a flash memory accessing unit 204. The flash memory accessing unit 204 is connected to the flash memory 40. The data interface unit 201 is connected to the south bridge chipset 10 for receiving, via the south bridge chipset 10, commands for controlling data access to the hard disk or the flash memory as well as data to be written in the hard disk or flash memory. The cache unit 202 is configured to cache the data to be written and the command. The flash memory accessing unit 204 receives the data and the command from the cache unit 202. The controlling unit 203 receives the command and the data from the cache unit 202, and controls the flash memory accessing unit 204 to exchange data with the south bridge chipset 10 via the data interface unit 201 according to the received command and data, as will be described in detail below.

As shown in FIG. 2, the flash accessing unit 204 further comprises a direct memory access (DMA) module 2041 for obtaining the cached command and data from the cache unit 202, a flash memory controller 2042 for controlling a data writing operation of the flash memory, and an error checking and correcting (ECC) module 2043 for checking and correcting errors in the data writing operation of the flash memory.

As the data storage speed of the flash memory 40 is faster than the data accessing speed of the conventional hard disk 30, for data accessing such as data writing, it is preferable to write data in the flash disk 40 at first. After receiving the command for writing data in the hard disk or the flash memory as well as the data to be written from the CPU via the south bridge chipset 10 and the data accessing unit 201, the controlling unit 203 analyzes the command to determine whether the size of the data to be written is larger than an available storage space on the flash memory 40 or not. If it is the case, the controlling unit 203 feedbacks this message to the mainboard chipset 10 so that a writing operation is operated on the conventional hard disk 30 based on the conventional operation of the mainboard chipset 10.

If it is determined that the size of the data to be written in is smaller than the available storage space on the flash memory 40, then the controlling unit 203 controls the flash memory accessing unit 204 to write data in the flash memory 40. Alternatively, after the data is written in the flash memory 40, the flash memory controller 2042 of the flash memory accessing unit 204 may detect whether the available storage space on the flash memory 40 is smaller than a preset threshold. If it is the case, then a notification is sent to the mainboard chipset 10, so that the latter writes data in the conventional hard disk 30 directly after the command is received, without communicating with the controlling unit 203. The preset threshold may be set up manually in advance.

Furthermore, while the flash memory 40 is used as a system disk, it may also serve as a conventional hard disk for caching data. A certain space on the flash memory 40 is left for caching data, after the flash memory 40 has stored a computer operating system and/or frequently used application programs, so that the problem that the conventional hard disk suffers a slow speed when storing small-sized files caused by the fact that a whole block of data is required to be continuously written in is addressed. Furthermore, when the data on the hard disk 30 is of no need to be called, the hard disk 30 may stop working temporarily so that its lifetime is extended.

### Embodiment 2

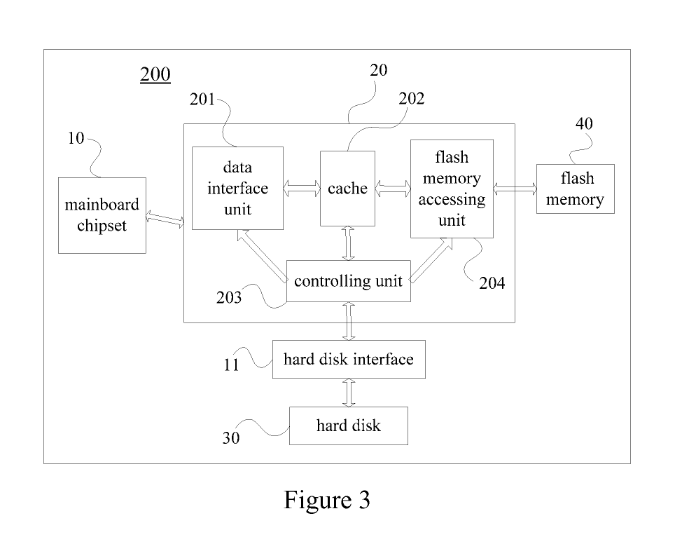

Referring to FIG. 3, a computer 200 according to a second embodiment of the first aspect of the present application comprises a CPU (not shown), a mainboard chipset 10 in communication with the CPU, a controller 20, a conventional hard disk 30 and a flash memory 40. The controller 20 may comprise a data interface unit 201, a cache unit 202, a controlling unit 203, a flash memory accessing unit 204 and a hard disk interface 11.

In this embodiment, the mainboard chipset 10, the conventional hard disk 30, the flash memory 40, the data interface unit 201, the cache unit 202, the flash memory accessing unit 204 and the hard disk interface 11 perform the same functions as that illustrated in the first embodiment, and thus will not be discussed here.

According to this embodiment, after receiving the command for writing data in the hard disk 30 or the flash memory 40 as well as the data to be written from the CPU via the interface unit 201 and the bridge chipset 10, the controlling unit 203 determines to write the data in the flash memory or the conventional hard disk according to the received command. If the data is to be written in the flash memory, the controlling unit 203 controls the flash memory accessing unit 204 to perform a writing operation on the flash memory. If the data is to be written in the conventional hard disk, the controlling unit 203 writes the data in the hard disk directly via the hard disk interface 11. The determination is the same as that illustrated in the first embodiment and thus the description thereof will be omitted here.

Alternatively, the flash memory unit 204, the hard disk interface 11, the cache unit 202, the interface unit 201 and the controlling unit 203 may be integrated in the mainboard chipset 10.

### Embodiment 3

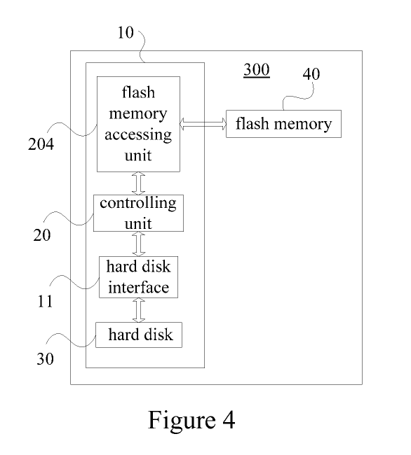

Referring to FIG. 4, a computer 300 according to a third embodiment of the first aspect of the present application comprises a CPU (not shown), a mainboard chipset 10 in communication with the CPU, a conventional hard disk 30, a flash memory accessing unit 204, a flash memory 40 connected to the flash memory accessing unit 204, a hard disk interface 11, a hard disk 30 connected to the hard disk interface 11, and a controller 20. The mainboard chipset 10, the conventional hard disk 30, the flash memory accessing unit 204, the flash memory 40, the hard disk interface 11 and the hard disk 30 in this embodiment perform the same function as that illustrated in the first embodiment.

In this embodiment, the flash memory accessing unit 204, the controller 20 and the hard disk interface 11 may be integrated in the mainboard chipset 10. The flash memory accessing unit 204 communicates with the controller 20 in the mainboard chipset 10. After receiving the writing command and the data to be written from the CPU of the computer 300, the controller 20 analyzes the writing command to determine whether the size of the data to be written is larger than the available storage space on the flash disk 40 or not. If it is the case, the data will be written in the conventional hard disk directly. Alternatively, the controller 30 may be a conventional south bridge processor.

Hereinafter, a method for accessing data in a conventional hard disk and a flash memory in a computer according to the present application will be described with reference to the accompanying drawings.

### Embodiment 1

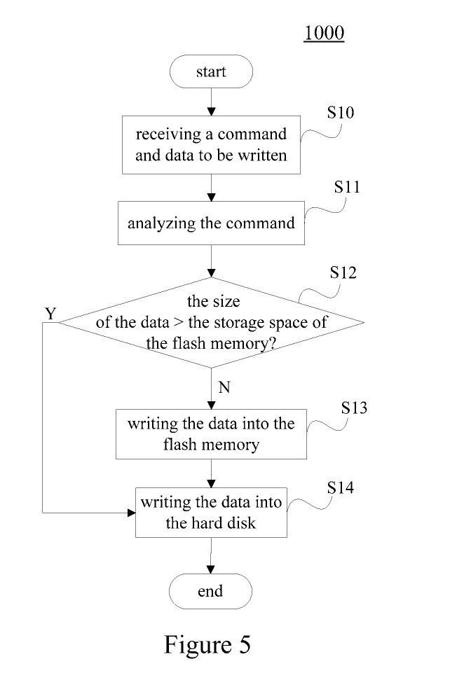

Referring to FIG. 5, a method 1000 for accessing data in conventional hard disk and a flash memory of a computer according to the first embodiment is shown. At step s10, the computer receives a data writing command and data to be written in. At step s11, the received command is analyzed. Then based on the analyzing result, at step s12, it is determined whether the size of the data to be written in is larger than the available storage space on the flash memory. If the size of the data to be written in is smaller than the available storage space on the flash memory, then the data is written in the flash memory at step s13, otherwise the data is written in the conventional hard disk at step s14.

### Embodiment 2

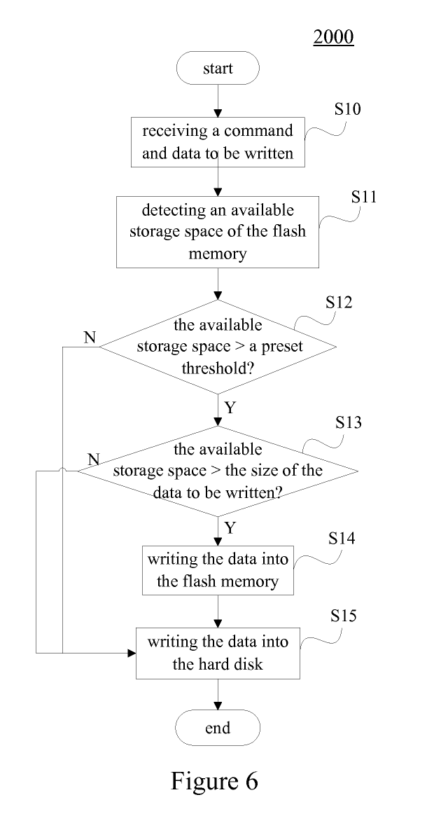

Referring to FIG. 6, a method 2000 for accessing data in the conventional hard disk and the flash memory of a computer according to a second embodiment is shown. At step s10, the data writing command and the data to be written in are received from the computer. At step s11, the available storage space on the flash memory is detected. Then at step s12, it is determined whether the available storage space on the flash memory is larger than a preset threshold. If the available storage space on the flash memory is smaller than the preset threshold, then at step s15 the data is directly written in the conventional hard disk; otherwise it is determined at step s13 whether the size of the data to be written in is larger than the available storage space on the flash memory. If the size of the data to be written in is determined to be larger than the available storage space on the flash memory, then the data is written in the conventional hard disk directly at step s15; otherwise the data is written in the flash memory at step s14.

### Embodiment 3

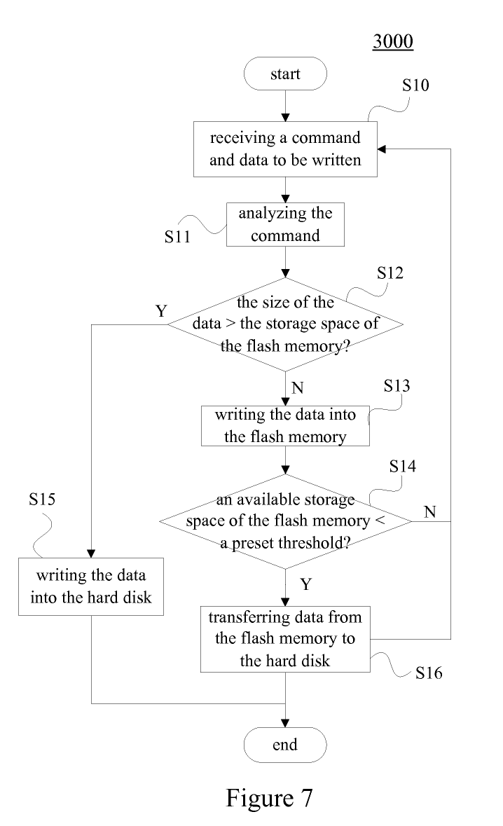

Referring to FIG. 7, a method 3000 for accessing data in the conventional hard disk and flash memory of a computer according to a third embodiment is shown. The steps of implementing method 300 comprise the following steps.

At step 10, the data writing command and the data to be written in are received. At step s11, the data writing command are analyzed. At step s12, it is determined whether the size of the data is larger than the available storage space on the flash memory according to the data writing command, if it is the case, the process goes to step s15, otherwise, the process goes to step 13. At step s13, the data is written in the flash memory. At step s14, it is determined whether the available storage space on the flash memory is smaller than a preset threshold; if it is the case, the process goes to step s16, otherwise, the process returns to step s10. At step s15, the data is written in the conventional hard disk. At step s16, part of data in the flash memory is selected to be transferred to the conventional hard disk, and then the process returns to step s10.

The above embodiments of the present application are provided only for an illustrative purpose without limiting the scope of protection of the present application. It is understood that those skilled in the art can make modifications or variations to the above embodiments in view of the description and drawings of the present application within the scope of the present application.

1. A computer comprising:
a mainboard chipset;
a conventional hard disk;
a flash memory;
a controller connected to the flash memory; and
wherein the controller is configured to determine a size of data to be accessed according to a command from the mainboard chipset, and selectively stores the data in the hard disk or the flash memory depending on a result of the determination.

2. A computer according to claim 1, wherein the mainboard chipset is a south bridge chipset.

3. A computer according to claim 2, wherein the controller comprising:
a data interface unit in communication with the south bridge chipset;
a controlling unit receiving the command via the data interface unit; and
a flash memory accessing unit connected to the flash memory,
wherein the controlling unit controls the flash memory accessing unit to exchange data with the south bridge chipset via the data interface unit according to the command.

4. A computer according to claim 3, wherein the controller further comprises a cache unit configured to cache the command and exchange data with the flash memory and the south bridge chipset; and
wherein the controlling unit further comprises a DMA module configured to receive the command and data from the cache unit; a flash memory controller configured to control a data access operation of the flash memory; and an ECC module configured to check and correct an error in the data access operation of the flash memory.

5. A computer according to claim 1, wherein the conventional hard disk is connected to the south bridge chip.

6. A computer according to claim 1, wherein the conventional hard disk is connected to the controlling unit.

7. A computer according to claim 3, wherein the controller is arranged in the mainboard chipset.

8. A computer according to claim 7, wherein the controller further comprises a cache unit between the data interface unit and the flash memory, and wherein the cache unit is configured to cache the command and the data to be written.

9. A computer according to claim 1, wherein the controller is further configured to detect an available storage space on the flash memory, and if the available storage space is smaller than a preset threshold, the data is controlled to be written in the conventional hard disk.

10. A method for accessing data in a computer, the computer comprising a conventional hard disk and a flash memory, the method comprising:
receiving a data writing command and data to be written;
analyzing the received command to determine whether a size of the data is larger than an available storage space on the flash memory; and
if the size of the data is larger than the available storage space on the flash memory, writing the data in the conventional hard disk, and otherwise, writing the data in the flash memory.

11. A method according to claim 10, further comprising:
determining whether the available storage space on the flash memory is larger than a preset threshold; and
if the available storage space on the flash memory is smaller than the preset threshold, transferring part of data on the flash memory to the conventional hard disk.

12. A method for accessing data in a computer, the computer comprising a conventional hard disk and a flash memory, the method comprising:
detecting whether an available storage space on the flash memory is larger than a preset threshold; and
if the available storage space is smaller than a preset threshold, then writing the data in the flash memory, and otherwise, determining whether a size of the data is larger than the available storage space on the flash memory, and
if the size of the data is smaller than the available storage space on the flash memory, then writing the data in the flash memory, and otherwise, writing the data in the conventional hard disk.
